(19) United States
(12) Patent Application Publication
(10) Pub. No.: US 2009/0257344 A1
(43) Pub. Date: Oct. 15, 2009

(54) ALL OPTICAL OFDM WITH INTEGRATED COUPLER BASED IFFT/FFT AND PULSE INTERLEAVING

(75) Inventors: Yue-Kai HUANG, PRINCETON, NJ (US); Ting WANG, West Windsor, NJ (US)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA, Princeton, NJ (US)

(21) Appl. No.: 12/241,858

(22) Filed: Sep. 30, 2008

Related U.S. Application Data
(60) Provisional application No. 61/044,606, filed on Apr. 14, 2008.

(51) Int. Cl. H04J 11/00

(52) U.S. Cl. 370/210

(57) ABSTRACT

A method and apparatus for all optical orthogonal frequency division multiplexing (OFDM) employing Inverse Fast Fourier Transform/Fast Fourier Transform by integrated coupler interferometrically.

### CROSS REFERENCE TO RELATED APPLICATIONS

This application claims the benefit under 35 U.S.C. § 119(e) of U.S. Provisional Application No. 61/044,606, filed Apr. 14, 2008, the entire contents and file wrapper of which are hereby incorporated by reference for all purposes into this application.

### FIELD OF THE INVENTION

This invention relates generally to the field of telecommunications. More particularly, it pertains to an all-optical orthogonal frequency division multiplexing transmission system and accompanying methods.

### BACKGROUND INFORMATION

Optical orthogonal frequency division multiplexing (OFDM) has been demonstrated to exhibit a robustness against chromatic dispersion (CD) and polarization mode dispersion (PMD)—particularly when accompanied by digital signal processing (DSP). Additional benefits include improved spectrum utilization and transmission rate through the effect of M-ary modulation.

Currently, sub-carrier multiplexing in optical OFDM is typically performed electronically, either using arbitrary waveform generators (AWGs) or high speed FPGAs for real time processing. As a result, the speed is limited by the electronic digital to analog (DAC) and analog to digital (ADC) converters which normally operate slower than 10 GS/s. In addition, modulation schemes exhibiting high linearity are also required to insure signal integrity in the electrical to optical (E/O) conversion.

In an attempt to overcome these and other deficiencies the prior art has explored all-optical OFDM systems including a 100 Gb/s transmission of two DQPSK modulated sub-carriers using a Mach-Zehnder based integrated planar lightwave circuit (PLC) and an all-optical OFDM system having four sub-carriers—with the aid of optical DFT processors.

### SUMMARY OF THE INVENTION

An advance is made in the art according to an exemplary embodiment of the present invention that is directed to an architecture/apparatus and accompanying method for high-speed all-optical OFDM through the effect of IFT/FFT by integrated coupler interferometry.

Accordingly, the all-optical OFDM transmission scheme uses integrated coupler interferometry and optical pulse shaping. The scheme is facilitated through the effect of high order FFT/IFFT on the amplitudes of an array of optical signals. Advantageously, the scheme uses passive optical networks constructed with familiar and readily available coupler technology. To generate the all-optical OFDM signal, the scheme uses optical pulse interleaving so the IFFT output amplitudes can be sampled and serialized. Of further advantage, transmission performance can be controlled and optimized using different pulse shapes, and spectral efficiency can be maintained by passing the OFDM signal through an optical filter before transmission.

The aforementioned and other features and aspects of the present invention are described in greater detail below.

### BRIEF DESCRIPTION OF THE DRAWING

FIG. 1 illustrates an all optical OFDM architecture according to the present invention;

FIG. 2 illustrates all optical IFFT/FFt using 2×2 couplers and phase shifters according to the present invention; and

FIG. 3 illustrates an overall architecture of the OFDM system of the present invention.

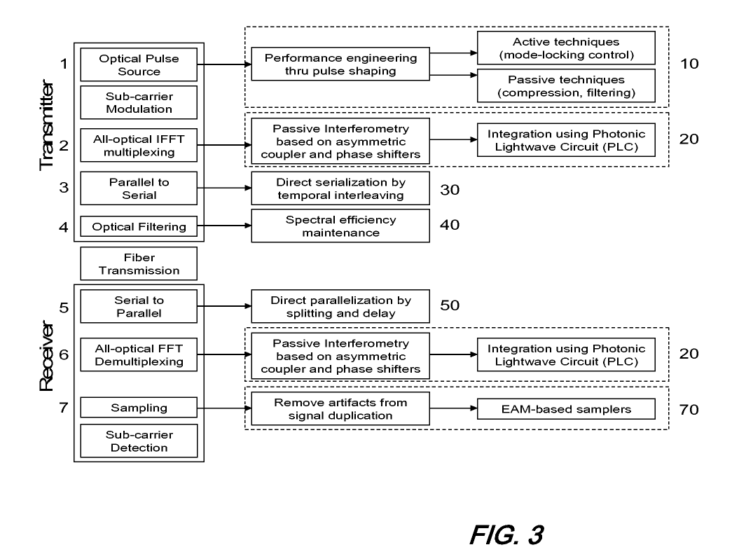

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

An underlying thesis of the present invention is that high-speed optical OFDM transmission can be achieved without speed limitations imposed by the electronic Digital-to-Analog/Analog-to-Digital Conversion. As noted earlier, the approach of the present invention permits the implementation of OFDM systems having a large numbers of sub-carriers using standard planar lightwave circuit (PLC) architectures, which may advantageously provide powerful and effective sub-carrier multiplexing. With an increased total number of sub-carriers, a number of those sub-carriers may be used for channel distortion compensation (e.g. pilot-assisted channel estimation). Moreover, increasing the number of sub-carriers may advantageously provide finer granularity for OFDM data traffic, which may prove to be an attractive path for network interfacing at the edge of the optical OFDM network.

When an OFDM system is operated according to the present invention, only one optical pulse source at a single wavelength is required to generate all the sub-carriers during OFDM signal generation. Consequently such a system requires a substantially lower system hardware budget than would be required for alternative systems. Additionally since systems operated according to the present invention utilize passive multiplexing/demultiplexing, it is offers a flexibility to change and control the input pulse without affecting the IFFT/FFT operation setting. As a result, through the effect of pulse shaping the OFDM transmission performance can be optimized for characteristics such as spectral efficiency and interference between sub-carriers.

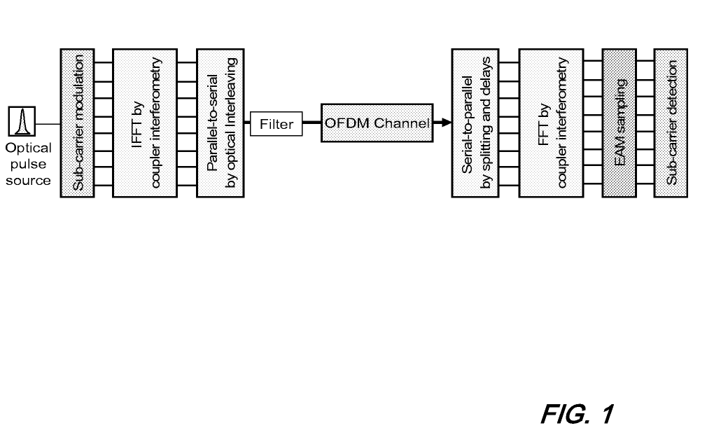

FIG. 1 is a block diagram showing the operation of the present method. With reference to that figure it may be seen that in a transmitter, an optical pulse source is split and modulated with sub-carrier symbols in a parallel fashion.

An IFFT is performed by taking all the sub-carriers as input pixels on a symbol-by-symbol basis. As may be appreciated by those skilled in the art, in optics, FFT/IFFT of the discrete array amplitudes can be implemented by interferometry using asymmetric couplers.

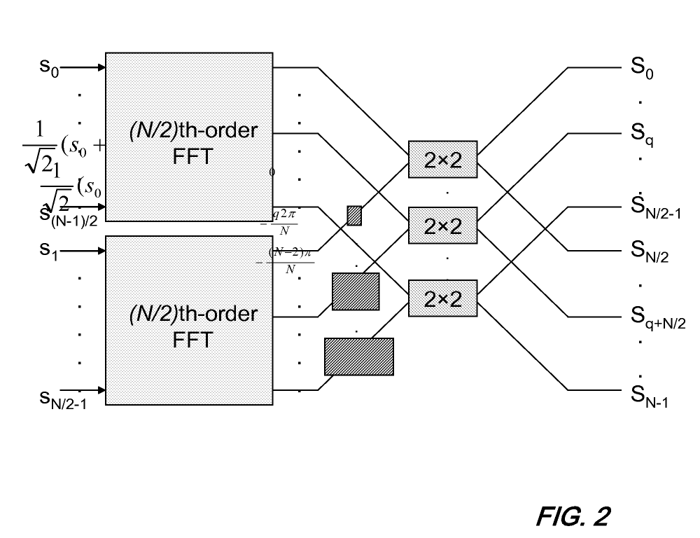

FIG. 2 is a block diagram of an all optical IFFT/FFT implemented using couplers and phase shifters (N-th order). With simultaneous reference to FIG. 1 and FIG. 2, the operation can be implemented by making proper interconnection between multiple 2×2 asymmetric couplers and appropriate phase shift elements. The interconnections are precisely controlled within a fraction of the wavelength, which those skilled in the art will appreciate can be achieved by PLCs—thereby maintaining proper interferometric operation between the optical signal arrays.

After the IFFT, a parallel-to-serial converter strings the generated values back temporally to form the OFDM signal. Before transmission, the signal is optically filtered to maintain spectral efficiency.

At a receiver, the received OFDM signal is first split and delayed/synchronized for parallel FFT. The reverse process de-multiplexes the sub-carriers output the sub-carrier symbols optically. For each sub-carrier channel, the duplication of signals during serial-to-parallel conversion creates undesired artifacts other than the relevant FFT results. An electro-absorption modulator (EAM) based optical sampler is used to eliminate these artifacts.

Finally, it is understood that the above-described embodiments are illustrative of only a few of the possible specific embodiments which can represent applications of the invention. Numerous and varied other arrangements can be made by those skilled in the art without departing from the spirit and scope of the invention.

More particularly, and as may now be appreciated, transmission performance, such as interference between sub-carrier samples and reduction of spectral envelope side-lobes, can be optimized by controlling the pulse shape of the optical source (1). By sending ordinary mode-locked laser pulse into a specially designed optical filter, such as super-structured FBGs, the width and shape of the pulse can be controlled thru the design of optical filter (10). A rectangular pulse shape is a good/preferred choice because of its longer duration for FFT interferometry and lower interference between sub-carriers.

At the receiver, the OFDM signal is converted back to parallel by splitting and delays (5) for synchronized FFT to obtain the sub-carrier symbols (6). An electro-absorption modulator (EAM) based optical sampler may be used for each sub-carrier to eliminate the artifacts generated by the splitting-and-delay synchronization.

All optical FFT/IFFT (2,6) enables the powerful and effective sub-carrier multiplexing/demultiplexing for all-optical OFDM transmission. Advantageously, our scheme is facilitated by the integration of interconnections, couplers, and phase shifters on PLCs (20). The technology provide simple solution to handle large number of sub-carriers.

Finally, parallelization and serialization of sub-carrier samples (3,5) are further facilitated through the use of optical pulse source (1). The fact that the source is shared among sub-carriers and independent of modulation and multiplexing allows us to perform transmission optimization on pulse shaping.

What is claimed is:

1. An Orthogonal Frequency Division Multiplexed transmission method comprising the steps of:
at a transmitter
generating and splitting an optical pulse source into a number of subcarriers;
modulating the subcarriers with subcarrier symbols in a parallel manner;
multiplexing the subcarriers by transforming the modulated subcarriers through the effect of an inverse fast fourier transform (IFFT);
performing a parallel to serial conversion of the transformed subcarriers through the effect of optical interleaving thereby generating an OFDM signal; and
filtering the OFDM signal to maintain spectral efficiency;
transmitting the filtered OFDM signal via an optical OFDM channel established between the transmitter and a receiver;
at the receiver
performing a serial to parallel conversion of the received OFDM signal;
demultiplexing the subcarriers by transforming the parallel OFDM signals through the effect of a fast fourier transform (FFT);
sampling the transformed symbols such that artifacts from signal duplication are removed; and
CHARACTERIZED IN THAT:
The IFFT and FFT are performed optically and interferometrically implemented through the effect of asymmetric couplers.

2. The method of claim 1 wherein said FFT/IFFT are performed through the effect of passive interferometry based on asymmetric couplers and phase shifters.

3. The method of claim 2 wherein said asymmetric couplers are 2×2 asymmetric couplers with appropriate phase shifters.

4. The method of claim 3 wherein said 2×2 asymmetric couplers and appropriate phase shifters are integrated onto a single photonic lightwave circuit (PLC).
